(19) United States
(12) Patent Application Publication
(10) Pub. No.: US 2024/0262649 A1
(43) Pub. Date: Aug. 8, 2024

(54) BINDING DEVICE, POST-PROCESSING DEVICE, AND IMAGE FORMING APPARATUS

(71) Applicant: FUJIFILM Business Innovation Corp., Tokyo (JP)

(72) Inventors: Kenya SUMIDA, Kanagawa (JP); Taku KIYOMASA, Kanagawa (JP); Takayuki UCHIYAMA, Kanagawa (JP); Takuya MAKITA, Kanagawa (JP); Takumi UEGANE, Kanagawa (JP); Shota SAITO, Kanagawa (JP); Hideki KAYASHIMA, Kanagawa (JP)

(73) Assignee: FUJIFILM Business Innovation Corp., Tokyo (JP)

(21) Appl. No.: 18/446,465

(22) Filed: Aug. 8, 2023

(30) Foreign Application Priority Data
Feb. 2, 2023 (JP) 2023-014435

(51) Int. Cl. B65H 37/04; B65H 5/36

(52) U.S. Cl. CPC B65H 37/04; B65H 5/36; B65H 2801/27

(57) ABSTRACT

A binding device includes: a binding unit that binds a plurality of media; a first moving unit that moves along a width direction of the medium; a second moving unit that is supported by the first moving unit, supports the binding unit, and moves in an inclined direction with respect to the width direction of the medium; and a contact unit that is supported by the first moving unit and comes into contact with a guide unit that extends in a movement direction of the first moving unit.

### CROSS-REFERENCE TO RELATED APPLICATIONS

This application is based on and claims priority under 35 USC 119 from Japanese Patent Application No. 2023-014435 filed Feb. 2, 2023.

### BACKGROUND

### (i) Technical Field

The present invention relates to a binding device, a post-processing device, and an image forming apparatus including the post-processing device.

### (ii) Related Art

Techniques described in JP2020-083633A, JP2012-148862A, and JP2012-111587A as below are known in the related art regarding a binding device that binds a bundle of media on which an image is recorded by an image recording device, a so-called stapler device.

JP2020-083633A (“0074” to “0112” (particularly, “0076”) and FIGS. 5 and 18) describes a configuration in which a roller-shaped or cylinder-shaped sliding member (40) is supported at a bottom portion of a moving portion (25) of a stapling unit (280) and the moving portion (25) moves along an engaging member (23) while a floor material and the sliding member (40) slide against each other.

JP2012-148862A (“0065” to “0102” (particularly, “0068”) and FIGS. 4 to 8) describes a configuration in which a rotation stop roller (331) that restricts rotation about a sliding shaft (311) of a moving base (330) by coming into contact with a frame (310) is provided on a lower side of the moving base (330) that moves on the frame (310), and the moving base (330) is moved along the sliding shaft (311) on the frame (310) by rotating the rotation stop roller (331).

JP2012-111587A (“0048” to “0114” (particularly, “0062”) and FIGS. 9 to 12) describes a technique in which a guide roller (77b) of a guide auxiliary member (77) is provided at an end portion of a support portion (62) of a stapler moving mechanism (53), and movement of the support portion (62) is stabilized by contact between the guide roller (77b) and a side wall (57b) of a base member (57).

### SUMMARY

Aspects of non-limiting embodiments of the present disclosure relate to a binding device, a post-processing device, and an image forming apparatus that suppress movement resistance of a binding device, compared to a configuration in which a binding device is guided along a width direction of a medium and an inclined direction with respect to the width direction by coming into contact with a guide unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a binding device including: a binding unit that binds a plurality of media; a first moving unit that moves along a width direction of the medium; a second moving unit that is supported by the first moving unit, supports the binding unit, and moves in an inclined direction with respect to the width direction of the medium; and a contact unit that is supported by the first moving unit and comes into contact with a guide unit that extends in a movement direction of the first moving unit.

### BRIEF DESCRIPTION OF THE DRAWINGS

Exemplary embodiment(s) of the present invention will be described in detail based on the following figures, wherein:

FIG. 1 is an overall explanatory view of an image forming apparatus of Example 1;

FIG. 2 is an explanatory view of a main portion of an image recording section of Example 1;

FIG. 3 is an explanatory view of a post-processing device of Example 1;

FIG. 4 is a cross-sectional view of a main portion of the post-processing device of Example 1;

FIG. 5 is an explanatory view of a sliding ring of Example 1; and

FIGS. 6A and 6B are explanatory views of a state of wear of the sliding ring, in which FIG. 6A is an explanatory view of a state of wear of the sliding ring of Example 1, and FIG. 6B is an explanatory view of a state of wear of a sliding ring in the related art.

### DETAILED DESCRIPTION

Next, examples as specific examples of an exemplary embodiment of the present invention will be described with reference to drawings, but the present invention is not limited to the following examples.

In addition, in order to facilitate the understanding of the following description, in the drawings, a front-rear direction is referred to as an X-axis direction, a right-left direction is referred to as a Y-axis direction, and an up-down direction is referred to as a Z-axis direction, directions or sides indicated by arrows X,-X, Y,-Y, Z, and-Z are respectively a front, rear, right, left, up, and down, or front side, rear side, right side, left side, upper side, and lower side. Additionally, in the drawings, one in which “·” is described in “○” means an arrow pointing from the back to the front of the paper, and one in which “×” is described in “○” means an arrow pointing from the front to the back of the paper.

In addition, in the description using the following drawings, illustrations other than members necessary for the description are omitted as appropriate for the sake of easy understanding.

### Example 1

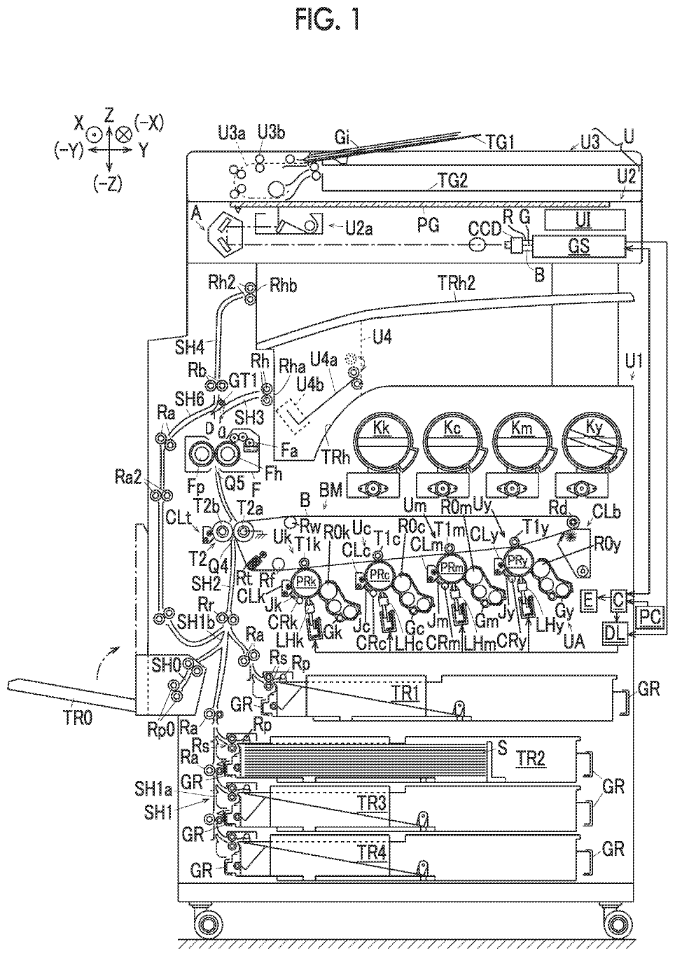

FIG. 1 is an overall explanatory view of an image forming apparatus of Example 1.

In FIG. 1, a copier U as an example of the image forming apparatus of Example 1 of the present invention has a printer section U1, which is an example of an image recording unit and is an example of an image recording device. A scanner section U2, which is an example of a reading unit and is an example of an image reading device, is supported above the printer section U1. An autofeeder U3 as an example of a document transporting device is supported above the scanner section U2.

A document tray TG1 as an example of a medium accommodating unit is disposed above the autofeeder U3. A plurality of documents Gi to be copied can be stacked and accommodated in the document tray TG1. Below the document tray TG1, a document discharge tray TG2 as an example of a document discharge unit is formed. A document transport roller U3b is disposed between the document tray TG1 and the document discharge tray TG2 along a document transport path U3a.

A platen glass PG as an example of a transparent platen is disposed on an upper surface of the scanner section U2. In the scanner section U2 of Example 1, a reading unit U2a as an example of a reading section is disposed below the platen glass PG. The reading unit U2a of Example 1 is supported to be movable in the right-left direction as an example of a sub-scanning direction, along a lower surface of the platen glass PG. The reading unit U2a is electrically connected to an image processing unit GS.

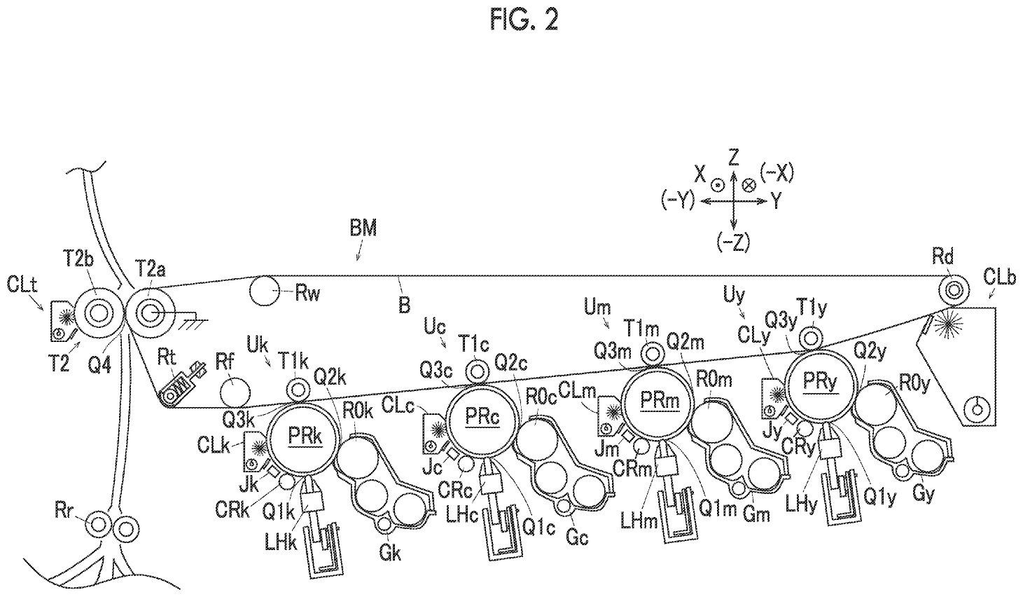

FIG. 2 is an explanatory view of a main portion of an image recording section of Example 1.

The image processing unit GS is electrically connected to a writing circuit DL of the printer section U1. The writing circuit DL is electrically connected to exposure devices LHy, LHm, LHc, and LHk as an example of a latent image forming unit.

As an example, the exposure devices LHy to LHk of Example 1 are configured by an LED head in which a plurality of LEDs are arranged in a main scanning direction. The exposure devices LHy to LHk are configured to output writing light beams corresponding to respective colors of Y, M, C, and K according to a signal input from the writing circuit DL.

In the writing circuit DL and a power supply circuit E, a writing timing and a power supply timing are controlled in accordance with a control signal from a control section C as an example of a control unit.

In FIG. 1, photoreceptors PRy, PRm, PRc, and PRk as an example of an image holding unit are disposed above the exposure devices LHy to LHk. In FIGS. 1 and 2, writing regions Q1y, Q1m, Q1c, and Q1k are configured by regions in which the photoreceptors PRy to PRk are irradiated with the writing light beams.

Charging rollers CRy, CRm, CRc, and CRk as an example of a charging unit are disposed upstream of the writing regions Q1y to Q1k in respective rotation directions of the photoreceptors PRy to PRk. The charging rollers CRy to CRk of Example 1 come into contact with the photoreceptors PRy to PRk and are supported to be rotatable there along.

Developing devices Gy, Gm, Gc, and Gk as an example of a developing unit are disposed downstream of the writing regions Q1y to Q1k in the rotation directions of the photoreceptors PRy to PRk. Development regions Q2y, Q2m, Q2c, and Q2k are configured by regions in which the photoreceptors PRy to PRk and the developing devices Gy to Gk respectively face each other.

Primary transfer rollers T1y, T1m, T1c, and T1k as an example of a primary transfer unit are disposed downstream of the developing devices Gy to Gk in the rotation directions of the photoreceptors PRy to PRk. Primary transfer regions Q3y, Q3m, Q3c, and Q3k are configured by regions in which the photoreceptors PRy to PRk and the primary transfer rollers T1y to T1k respectively face each other.

Photoreceptor cleaners CLy, CLm, CLc, and CLk as an example of a cleaning unit are disposed downstream of the primary transfer rollers T1y to T1k in the rotation directions of the photoreceptors PRy to PRk.

Static eliminators Jy, Jm, Jc, and Jk, which are an example of a static elimination unit and are an example of a static elimination device, are disposed downstream of the photoreceptor cleaners CLy to CLk in the rotation directions of the photoreceptors PRy to PRk.

The Y-color photoreceptor PRy, the charging roller CRy, the exposure device LHy, the developing device Gy, the primary transfer roller T1y, the photoreceptor cleaner CLy, and the static eliminator Jy constitute a Y-color image forming unit Uy as an example of a Y-color visible image forming unit of Example 1 for forming a Y-color toner image. Similarly, the photoreceptors PRm, PRc, and PRk, the charging rollers CRm, CRc, and CRk, the exposure devices LHm, LHc, and LHk, the developing devices Gm, Gc, and Gk, the primary transfer rollers T1m, T1c, and T1k, the photoreceptor cleaners CLm, CLc, and CLk, and the static eliminators Jm, Jc, and Jk constitute M-, C-, and K-color image forming units Um, Uc, and Uk.

A belt module BM as an example of an intermediate transfer device is disposed above the photoreceptors PRy to PRk. The belt module BM has an intermediate transfer belt B, which is an example of an image holding unit and is an example of an intermediate transfer unit. The intermediate transfer belt B is formed of an endless band-shaped member.

The intermediate transfer belt B of Example 1 is supported to be rotatable by a tension roller Rt as an example of a tensioning unit, a walking roller Rw as an example of a deviation correction unit, an idler roller Rf as an example of a driven unit, a back-up roller T2a as an example of a unit facing a secondary transfer region, the primary transfer rollers T1y to T1k, and a drive roller Rd as an example of a drive member. In Example 1, the intermediate transfer belt B rotates in a case where a drive force is transmitted to the drive roller Rd.

A secondary transfer roller T2b as an example of a secondary transfer unit is disposed at a position facing the back-up roller T2a with the intermediate transfer belt B interposed therebetween. The back-up roller T2a, the secondary transfer roller T2b, and the like constitute a secondary transfer device T2 of Example 1 as an example of a transfer device. A secondary transfer region Q4 is configured by a region in which the secondary transfer roller T2b comes into contact with the intermediate transfer belt B.

A belt cleaner CLb as an example of a cleaning device for an intermediate transfer body is disposed downstream of the secondary transfer region Q4 in a rotation direction of the intermediate transfer belt B.

A transfer device T1+T2+B of Example 1 as an example of a transfer unit is constituted by the primary transfer rollers T1y to T1k, the intermediate transfer belt B, the secondary transfer device T2, and the like. In addition, an image recording section Uy to Uk+T1+T2+B of Example 1 is constituted by the image forming units Uy to Uk and the transfer device T1+T2+B.

In FIG. 1, a pair of right and left guide rails GR as an example of a guide unit are provided in four stages below the image forming units Uy to Uk. The guide rails GR respectively support paper feed trays TR1, TR2, TR3, and TR4 as an example of a medium accommodating unit so as to enter and exit in the front-rear direction. Recording sheets S as an example of a medium are accommodated in the paper feed trays TR1 to TR4.

A pick-up roller Rp as an example of a taking-out unit is disposed on an upper left side of each of the paper feed trays TR1 to TR4. A separating roller Rs as an example of a separating unit is disposed downstream of the pick-up roller Rp in a transport direction of the recording sheet S. A paper feed path SH1 extending upward as an example of a medium transport path is formed downstream of the separating roller Rs in the transport direction of the recording sheet S. A plurality of transport rollers Ra as an example of a transporting unit are disposed on the paper feed path SH1.

A manual tray TR0 as an example of a medium accommodating unit is disposed at a lower left portion of the copier U. A pick-up roller Rp0 is disposed at an upper right portion of the manual tray TR0, and a manual paper feed path SH0 extends. The manual paper feed path SH0 joins the paper feed path SH1.

On the paper feed path SH1, a registration roller Rr as an example of a transport timing adjusting unit is disposed upstream of the secondary transfer region Q4. A transport path SH2 extends from the registration roller Rr toward the secondary transfer region Q4.

A fixing device F as an example of a fixing unit is disposed downstream of the secondary transfer region Q4 in the transport direction of the recording sheet S. The fixing device F has a heating roller Fh as an example of a fixing member for heating and a pressing roller Fp as an example of a fixing member for pressing. A fixing region Q5 is configured by a contact region between the heating roller Fh and the pressing roller Fp.

A lower paper discharge tray TRh as an example of a medium discharge unit is formed on an upper surface of the printer section U1. In Example 1, a finisher U4 as an example of a post-processing device is provided in the lower paper discharge tray TRh. Above the fixing device F, a paper discharge path SH3 as an example of a transport path extends toward the lower paper discharge tray TRh. A paper discharge roller Rh as an example of a medium transporting unit is disposed at a downstream end of the paper discharge path SH3.

An upper paper discharge tray TRh2 as an example of the medium discharge unit is disposed above the lower paper discharge tray TRh. An upper transport path SH4 that branches off from the paper discharge path SH3 and extends toward the upper paper discharge tray TRh2 is formed above the fixing device F.

On the upper transport path SH4, a reversing roller Rb that can rotate in forward and reverse directions as an example of the medium transporting unit is disposed. Above a branch position between the paper discharge path SH3 and the upper transport path SH4, a reversing path SH6 as an example of the medium transport path branches to a lower left side from the upper transport path SH4.

A gate GT1 as an example of a switching unit is disposed across a branch portion between the paper discharge path SH3 and the upper transport path SH4 and a branch portion between the upper transport path SH4 and the reversing path SH6. The gate GT1 guides the recording sheet S from the fixing device F toward the lower paper discharge tray TRh, and is supported to switch between a first guide position (second position) at which the recording sheet S is guided from the upper transport path SH4 to the reversing path SH6 and a second guide position (first position) at which the recording sheet S is guided from the fixing device F to the upper transport path SH4.

On the reversing path SH6, a plurality of transport rollers Ra as an example of the medium transporting unit are disposed. A downstream end of the reversing path SH6 joins the paper feed path SH1 upstream of the registration roller Rr.

### Description of Image Forming Operation

In the copier U of Example 1 having the above configuration, in a case where the document Gi is manually placed on the platen glass PG by a worker and copied, the reading unit U2a moves in the right-left direction from an initial position and the document Gi on the platen glass PG is scanned while being exposed. In a case where the document Gi is automatically transported by the autofeeder U3 and copied, the plurality of documents Gi accommodated in the document tray TG1 are sequentially transported and passed to a document reading position on the platen glass PG and discharged to the document discharge tray TG2. The documents Gi that sequentially pass through the reading position on the platen glass PG are exposed to the reading unit U2a and scanned. Reflected light from the document Gi is received by the reading unit U2a. The reading unit U2a converts the received reflected light of the document Gi into an electrical signal. In a case where both sides of the document Gi are read, the document Gi is also read by a reading sensor.

The electrical signal output from the reading unit U2a is input to the image processing unit GS. The image processing unit GS converts the electrical signal of R, G, and B color images read by the reading unit U2a into yellow (Y), magenta (M), cyan (C), and black (K) image information for forming a latent image. The image processing unit GS outputs the converted image information to the writing circuit DL of the printer section U1. In a case where the image is a monochromatic image, so-called monochrome, the image processing unit GS outputs image information of only black K to the writing circuit DL.

The writing circuit DL outputs a control signal corresponding to the input image information to the exposure devices LHy to LHk. The exposure devices LHy to LHk output the writing light beams corresponding to the control signal.

Each of the photoreceptors PRy to PRk is rotatably driven as image formation is started. A charging voltage is applied to the charging rollers CRy to CRk from the power supply circuit E. Therefore, surfaces of the photoreceptors PRy to PRk are charged by the charging rollers CRy to CRk. Electrostatic latent images are formed on the surfaces of the charged photoreceptors PRy to PRk in the writing regions Q1y to Q1k by the exposure devices LHy to LHk. The electrostatic latent images of the photoreceptors PRy to PRk are developed into toner images as an example of a visible image by the developing devices Gy to Gk in the development regions Q2y to Q2k.

The developed toner images are transported to the primary transfer regions Q3y to Q3k that come into contact with the intermediate transfer belt B as an example of the intermediate transfer body. In the primary transfer regions Q3y to Q3k, a primary transfer voltage having a polarity opposite to the charging polarity of the toner is applied to the primary transfer rollers T1y to T1k from the power supply circuit E. Therefore, the respective toner images on the photoreceptors PRy to PRk are transferred to the intermediate transfer belt B by the primary transfer rollers T1y to T1k. In a case of multi-color toner images, a toner image on a downstream side is transferred by being superimposed on a toner image transferred to the intermediate transfer belt B in the primary transfer region on an upstream side.

Residues and deposits of the photoreceptors PRy to PRk after the primary transfer are cleaned by the photoreceptor cleaners CLy to CLk. The surfaces of the photoreceptors PRy to PRk after cleaning are subjected to static elimination by the static eliminators Jy to Jk. The surfaces of the photoreceptors PRy to PRk after static elimination are re-charged by the charging rollers CRy to CRk.

The monochromatic or multi-color toner images transferred onto the intermediate transfer belt B by the primary transfer rollers T1y to T1k in the primary transfer regions Q3y to Q3k are transported to the secondary transfer region Q4.

The recording sheet S on which an image is to be recorded is taken out by the pick-up rollers Rp of the paper feed trays TR1 to TR4 used. In a case where a plurality of recording sheets S are stacked and taken out, the recording sheets S taken out by the pick-up roller Rp are separated one by one by the separating roller Rs. The recording sheet S separated by the separating roller Rs is transported to the paper feed path SH1 by the transport roller Ra. The recording sheet S transported to the paper feed path SH1 is sent to the registration roller Rr. The recording sheet S loaded on the manual tray TR0 is also sent to the paper feed path SH1 through the manual paper feed path SH0 by the pick-up roller Rp0.

The registration roller Rr transports the recording sheet S to the secondary transfer region Q4 in accordance with a timing at which the toner image formed on the intermediate transfer belt B is transported to the secondary transfer region Q4. A secondary transfer voltage having a polarity opposite to the charging polarity of the toner is applied to the secondary transfer roller T2b by the power supply circuit E. Therefore, the toner image on the intermediate transfer belt B is transferred from the intermediate transfer belt B to the recording sheet S.

After the secondary transfer, deposits and the like adhering to a surface of the intermediate transfer belt B are cleaned by the belt cleaner CLb.

The recording sheet S on which the toner image is secondarily transferred is heated and fixed while being passed through the fixing region Q5.

In a case where post-processing is performed, the recording sheet S on which the image is fixed is transported to the finisher U4 as the example of the post-processing device provided in the lower paper discharge tray TRh. In a case where the recording sheet S is not subjected to the post-processing, the recording sheet S is transported to the upper paper discharge tray TRh2. In a case where the recording sheet S is transported to the lower paper discharge tray TRh, the gate GT1 moves to the first guide position. Therefore, the recording sheet S sent out from the fixing device F is transported to the paper discharge path SH3. The recording sheet S transported to the paper discharge path SH3 is transported toward the finisher U4 and the lower paper discharge tray TRh by the paper discharge roller Rh.

The finisher U4 performs a binding process as an example of post-processing on the recording sheet S, and then discharges the recording sheet S to the lower paper discharge tray TRh.

In a case where the recording sheet S is discharged to the upper paper discharge tray Rh2, the gate GT1 moves to the second guide position and the recording sheet S is discharged to the upper paper discharge tray TRh2.

In a case where the recording sheet S is subjected to two-sided printing, the gate GT1 moves to the second guide position. Then, in a case where a rear end of the recording sheet S passes through the gate GT1, the gate GT1 moves to the first guide position and the reversing roller Rb rotates in the reverse direction. Therefore, the recording sheet S is guided by the gate GT1 and sent to the reversing path SH6. The recording sheet S transported to the reversing path SH6 is sent to the registration roller Rr in a state where front and back sides are reversed.

### Description of Finisher U4

In FIG. 1, the finisher U4 of Example 1 has a compile tray U4a as an example of a loading unit. A stapling device U4b as an example of a binding device is disposed upstream of the compile tray U4a in a medium transport direction.

The lower paper discharge tray TRh is disposed downstream of the compile tray U4a in the medium transport direction.

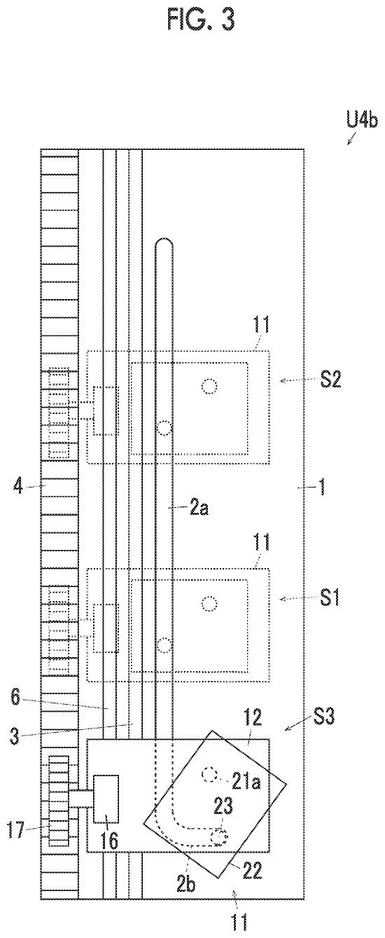

FIG. 3 is a plan view of the post-processing device of Example 1.

In FIG. 3, the stapling device U4b of Example 1 has a guide rail 1 as an example of a guide member. As an example of a second guide unit, a guide groove 2 extending in the front-rear direction, that is, in a medium width direction is formed in the guide rail 1. The guide groove 2 of Example 1 has an end binding guide portion 2a extending in the front-rear direction as an example of an end binding guide portion and a corner binding guide portion 2b as an example of a corner binding guide portion inclined to the right in an arc shape at a front end portion thereof.

In the guide rail 1, a guide track 3 as an example of a guide unit is disposed on the left side of the guide groove 2. The guide track 3 of Example 1 is formed in a convex shape extending in the medium width direction.

Rack teeth 4 as an example of a drive unit are disposed at a left end portion of the guide rail 1. The rack teeth 4 of Example 1 have a plate shape extending in the front-rear direction, that is, the medium width direction, and a gear is formed on an upper surface thereof.

A guide shaft 6 as an example of a third guide unit is supported between the rack teeth 4 and the guide track 3. The guide shaft 6 is formed in a rod shape extending in the medium width direction.

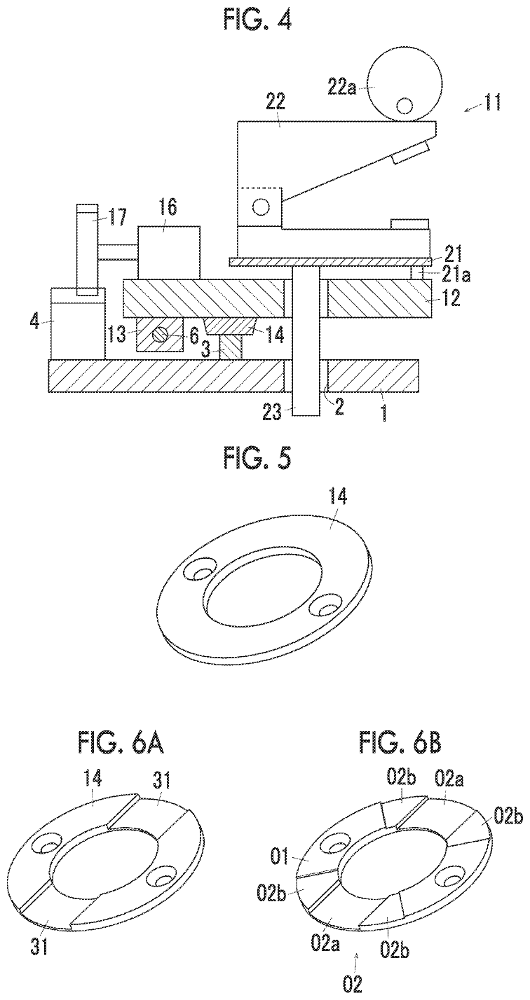

FIG. 4 is a cross-sectional view of a main portion of the post-processing device of Example 1.

A stapling unit 11 as an example of a binding unit is disposed above the guide rail 1.

In FIGS. 3 and 4, the stapling unit 11 has a carriage portion 12 as an example of a first moving unit.

The carriage portion 12 is provided with a guided portion 13 as an example of a third guided unit. The guide shaft 6 passes through the guided portion 13. Therefore, the guided portion 13 can move along the guide shaft 6, and the carriage portion 12 can move in the front-rear direction, that is, in the medium width direction along the guide shaft 6.

FIG. 5 is an explanatory view of a sliding ring of Example 1.

In FIGS. 4 and 5, a sliding ring 14 as an example of a contact unit is supported at a bottom portion of the carriage portion 12. The sliding ring 14 comes into contact with an upper surface of the guide track 3. Therefore, in a case where the carriage portion 12 moves in the front-rear direction, the sliding ring 14 relatively moves while sliding on the upper surface of the guide track 3.

For example, at least a portion of the sliding ring 14 that comes into contact with the guide track 3 is desirably made of a material having a low friction coefficient. As an example, the entire sliding ring 14 maybe made of a fluororesin. Alternatively, the sliding ring 14 may 14 maybe made of a metal to form a film of a fluororesin on a surface thereof.

In Example 1, the sliding ring 14 is formed in an annular shape in which a center portion of a disk is hollowed out, that is, a so-called ring shape. That is, the sliding ring 14 is formed in a shape such as a flat washer. The sliding ring 14 is not limited to the ring shape, and may have any shape such as a disk shape, an angular plate shape, a corrugated plate shape, and a wave washer shape. Here, the sliding ring 14 of Example 1 has a smaller contact area with the guide track 3 than a member of which a center portion is not hollowed out. Therefore, the sliding ring 14 of Example 1 is smaller in frictional resistance and sliding load during movement of the carriage portion 12 than the disk shape or the angular plate shape.

A moving motor 16 as an example of a drive source for movement is supported on a left portion of the carriage portion 12. A drive gear 17 as an example of a gear, to which a drive force is transmitted from the moving motor 16, meshes with the rack teeth 4. Therefore, in response to forward rotation, reverse rotation, and stop of the moving motor 16, the carriage portion 12 can move in the front-rear direction along the guide rail 1, and stop at end binding positions S1 and S2 and a corner binding position S3.

A moving mechanism 4+16 of Example 1 is constituted by the rack teeth 4 and the moving motor 16.

A rotary base 21 as an example of a second moving unit is disposed above the carriage portion 12. The rotary base 21 is supported to be rotatable relative to the carriage portion 12 about a rotary shaft 21a. A staple-free stapler 22 as an example of a binding unit is supported on an upper portion of the rotary base 21. The staple-free stapler 22 clamps the recording sheets S and binds a bundle of the recording sheets S without using a staple in response to an operation of an operation motor 22a as an example of a drive source for operation. As a method of binding the recording sheets S without a staple, any known method in the related art can be adopted. A method of tearing a part of the paper can also be adopted, and a method of applying a pressure in a thickness direction of the paper to deform the paper can also be adopted. In Example 1, although the staple-free stapler 22 is described as an example of the binding unit, the present invention is not limited thereto. A stapler that binds the recording sheets S by driving a staple into the recording sheets S can also be used.

A guided shaft 23 as an example of a guided unit is supported at a lower surface of a left portion of the rotary base 21. The guided shaft 23 passes through the carriage portion 12 and fits into the guide groove 2. Therefore, in a state where the carriage portion 12 is moved to the end binding positions S1 and S2, the guided shaft 23 is in contact with the end binding guide portion 2a, and the rotary base 21 and the staple-free stapler 22 enter a state indicated by the broken lines in FIG. 3, so that binding can be performed in a state where a binding angle is directed along an end edge of the recording sheets S. In a state where the carriage portion 12 is moved to the corner binding position S3, the guided shaft 23 comes into contact with the corner binding guide portion 2b, and the rotary base 21 and the staple-free stapler 22 rotate about the rotary shaft 21a and enter a state indicated by the solid line in FIG. 3. In this state, the binding angle of the staple-free stapler 22 is in a state of being inclined with respect to a case of the end binding.

### Action of Example 1

In the copier U of Example 1 having the above configuration, a bundle of the recording sheets S loaded on the compile tray U4a is subjected to the binding process (post-processing) by the staple-free stapler 22. The stapling unit 11 moves to the end binding positions S1 and S2 and the corner binding position S3 according to the setting of end binding and corner binding of a user, and the binding process is performed.

In a case where the stapling unit 11 moves, the sliding ring 14 of the carriage portion 12 moves while coming into sliding contact with the guide track 3. In a case where a roller-shaped or cylinder-shaped configuration described in the related art is used, the roller or the like rotates to move a unit. In a case where a roller or the like is used, there is an advantage that rubbing noise is less likely to be generated, compared to a case where sliding is performed as in Example 1. However, the roller and the like require a rotary shaft, a flange for supporting the rotary shaft, and the like, which causes a problem that a large number of components are prone to failure, a problem that rattling occurs due to component accuracy, and a problem that a space for the roller and the like to rotate is required and it is difficult to reduce a size of a configuration. In particular, the staple-free stapler 22 adopts a method of tearing the paper or deforming the paper by applying a strong force, and is likely to require a strong force compared to a stapler. Therefore, the staple-free stapler 22 needs to use a large-capacity motor compared to the stapler and tends to be larger and heavier in an overall configuration. Therefore, in the roller or the like, there is a problem that a load applied to the roller or the like is increased due to a weight of a heavy unit, a failure or rattling is likely to occur, and a service life is likely to be shortened. Contrary to this, in Example 1, since the sliding ring 14 is used, the number of components is small, the component accuracy is less likely to be a problem, and the configuration is easy to be miniaturized, compared to the case where a roller or the like is used. Furthermore, even a heavy staple-free stapler 22 can cope with a service life simply by increasing a thickness of the sliding ring 14.

FIGS. 6A and 6B are explanatory views of a state of wear of the sliding ring, in which FIG. 6A is an explanatory view of a state of wear of the sliding ring of Example 1, and FIG. 6B is an explanatory view of a state of wear of a sliding ring in the related art.

In the stapling unit 11 of Example 1, in a case where the carriage portion 12 moves to the corner binding position S3, only the rotary base 21 and the staple-free stapler 22 rotate, and the carriage portion 12 does not rotate. In a post-processing device in the related art, a configuration is also adopted in which a carriage portion is also inclined along a corner binding guide portion according to a binding angle of corner binding. In such a configuration in the related art, in a case where the sliding ring 14 is adopted, the guide track has not only a linear portion (a portion along a paper width direction) parallel to the end binding guide portion 2a, but also a portion (a portion along an inclined direction with respect to the paper width direction) along the corner binding guide portion 2b.

In the case of the linear guide track 3 as in Example 1, even if the sliding ring 14 wears over time due to the use of the stapling unit 11, only a linear worn portion 31 along the guide track 3 wears as shown in FIG. 6A. Even in a case where the sliding ring 14 in a linearly worn state such as the worn portion 31 is continuously used, there is almost no adverse effect on the movement of the carriage portion 12.

On the other hand, in the configuration in which the guide track also has the portion along the corner binding guide portion, as shown in FIG. 6B, in a worn portion 02 of a sliding ring 01, not only end binding worn portions 02a corresponding to the linear portion, but also corner binding worn portions 02b corresponding to the corner binding guide portion are generated. Here, in a case where frequencies of the end binding and the corner binding are different, a step may be generated between the end binding worn portions 02a and the corner binding worn portions 02b as shown in FIG. 6B. When this step is generated, problems such as poor inclination of the carriage portion, resistance during movement, an increase in load, and deterioration of accuracy of the binding position are likely to occur.

Therefore, in Example 1, the carriage portion 12 does not rotate and the sliding ring 14 slides only in the direction along the linear guide track 3. Therefore, compared to a configuration in which the stapling unit is guided depending on the end binding or the corner binding, a movement resistance and a movement load of the stapling unit 11 are suppressed, and the occurrence of poor inclination of the staple-free stapler 22 and deterioration of the accuracy of the binding position are also suppressed.

In addition, in the stapling unit 11 of Example 1, corner binding can be possible at a binding angle inclined with respect to the binding angle in the case of the end binding by the rotation of the rotary base 21. At this time, the rotary base 21 is rotated by the contact between the guided shaft 23 and the corner binding guide portion 2b, and is rotated without using a dedicated drive source for rotating the rotary base 21. Therefore, compared to a case where a dedicated drive source is used, the number of components is reduced, a reduction in weight is achieved, and the load on the sliding ring 14 is also reduced. In addition, manufacturing costs and maintenance costs associated with replacement of components are likely to be suppressed.

Furthermore, the sliding ring 14 of Example 1 is disposed at the bottom portion of the stapling unit 11 and supports the load of the stapling unit 11. Therefore, an increase in sliding resistance tends to occur. However, since a low friction material is used, the frictional resistance and sliding resistance are suppressed compared to a case where a low friction material is not used.

In addition, in Example 1, the moving motor 16 is disposed on the left side of the carriage portion 12, and is not disposed below the carriage portion 12. Therefore, an increase in the overall height of the stapling unit 11 is suppressed.

Furthermore, in the carriage portion 12 of Example 1, the guided portion 13 is guided by the guide shaft 6, and is smoothly guided compared to a configuration in which a shaft is not used.

### Modification Examples

Although the example of the present invention has been described in detail above, the present invention is not limited to the above example, and various changes can be made within the scope of the gist of the present invention described in the claims. Modification Examples (H01) to (H06) of the present invention are illustrated below.

(H01) In the example, the copier U has been described as an example of the image forming apparatus. However, the present invention is not limited thereto, and the image forming apparatus can also be configured by, for example, a printer, a fax machine, or a multifunction machine having a plurality of functions thereof or all of the functions thereof. In addition, the present invention is not limited to an electrophotographic image forming apparatus, and can also be applied to any image forming apparatus such as an inkjet type image forming apparatus or a heat transfer printing type image forming apparatus.

(H02) In the example, the configuration in which the developing agents of four colors are used in the copier U has been described. However, the present invention is not limited thereto and for example, the present invention can also be applied to a monochromatic image forming apparatus or a multi-color image forming apparatus in which three or less colors or five or more colors are used.

(H03) In the example, the endless band-shaped intermediate transfer belt B has been described as an example of the image holding unit. However, the present invention is not limited thereto. For example, the present invention can also be applied to a cylindrical intermediate transfer drum, a photoreceptor drum, and a photoreceptor belt. In addition, the present invention can also be applied to a configuration in which no intermediate transfer body is provided and an image from a photoreceptor is directly recorded on the recording sheet S.

(H04) In the above example, the configuration in which the stapling device U4b has the stapling unit 11 having the staple-free stapler 22 has been described. However, the present invention is not limited thereto. For example, the present invention can be applied to a configuration in which two stapling units are disposed on the guide rail 1. In addition, the present invention is not limited to the stapling unit 11, and the present invention can also be applied to a punching unit for forming a punched hole, a unit for forming a folded line, a unit for forming a perforated line, and the like.

(H05) In the example, the configuration in which the finisher U4 is provided on the lower paper discharge tray TRh has been described, but the present invention is not limited thereto. A post-processing device externally attached to a side portion of the copier U may also be used.

(H06) In the example, the configuration in which the rotary base 21 as an example of the second moving unit rotates relative to the carriage portion 12 has been described, but the present invention is not limited thereto. For example, the present invention can be applied to any form such as a configuration in which the rotary base 21 slides with respect to the carriage portion 12, and a form in which rotation and sliding are combined for movement.

### Supplementary Notes

(((1)))

A binding device comprising:

a binding unit that binds a plurality of media; a first moving unit that moves along a width direction of the medium;

a second moving unit that is supported by the first moving unit, supports the binding unit, and moves in an inclined direction with respect to the width direction of the medium; and a contact unit that is supported by the first moving unit and comes into contact with a guide unit that extends in a movement direction of the first moving unit.

(((2)))

The binding device according to (((1))),

wherein the second moving unit is supported by the first moving unit to be rotatable about a rotary shaft, and moves in the inclined direction about the rotary shaft.

(((3)))

The binding device according to (((2))), further comprising:

a guided unit that is disposed at a position away from the rotary shaft and is guided by a second guide unit extending in the movement direction of the first moving unit and in a movement direction of the second moving unit,

wherein, in a case where the guided unit is guided to a portion of the second guide unit along the movement direction of the second moving unit, the guided unit moves the second moving unit about the rotary shaft.

(((4)))

The binding device according to any one of (((1))) to (((3))),

wherein the contact unit is disposed at a bottom surface of the first moving unit.

(((5)))

The binding device according to (((4))),

wherein a portion of the contact unit that comes into contact with the guide unit is made of a low friction material.

(((6)))

The binding device according to any one of (((1))) to (((5))), further comprising:

a moving mechanism that is disposed on an inner side in a medium transport direction with respect to the binding unit and moves the first moving unit.

(((7)))

The binding device according to (((6))), further comprising:

a third guide unit that is disposed on the inner side in the medium transport direction with respect to the guide unit, is formed in a rod shape extending in the width direction of the medium, and guides the first moving unit.

(((8)))

A post-processing device comprising:

a loading unit on which media are loaded; and

the binding device according to any one of (((1))) to (((7))) that binds the media loaded on the loading unit.

(((9)))

An image forming apparatus comprising:

an image recording device that records an image on a medium; and

the post-processing device according to (((8))) that performs post-processing on the medium on which the image is recorded by the image recording device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A binding device comprising:
a binding unit that binds a plurality of media;
a first moving unit that moves along a width direction of the medium;
a second moving unit that is supported by the first moving unit, supports the binding unit, and moves in an inclined direction with respect to the width direction of the medium; and
a contact unit that is supported by the first moving unit and comes into contact with a guide unit that extends in a movement direction of the first moving unit.

2. The binding device according to claim 1,
wherein the second moving unit is supported by the first moving unit to be rotatable about a rotary shaft, and moves in the inclined direction about the rotary shaft.

3. The binding device according to claim 2, further comprising:
a guided unit that is disposed at a position away from the rotary shaft and is guided by a second guide unit extending in the movement direction of the first moving unit and in a movement direction of the second moving unit,
wherein, in a case where the guided unit is guided to a portion of the second guide unit along the movement direction of the second moving unit, the guided unit moves the second moving unit about the rotary shaft.

4. The binding device according to claim 1,
wherein the contact unit is disposed at a bottom surface of the first moving unit.

5. The binding device according to claim 4,
wherein a portion of the contact unit that comes into contact with the guide unit is made of a low friction material.

6. The binding device according to claim 1, further comprising:
a moving mechanism that is disposed on an inner side in a medium transport direction with respect to the binding unit and moves the first moving unit.

7. The binding device according to claim 6, further comprising:
a third guide unit that is disposed on the inner side in the medium transport direction with respect to the guide unit, is formed in a rod shape extending in the width direction of the medium, and guides the first moving unit.

8. A post-processing device comprising:
a loading unit on which media are loaded; and
the binding device according to claim 1 that binds the media loaded on the loading unit.

9. A post-processing device comprising:
a loading unit on which media are loaded; and
the binding device according to claim 2 that binds the media loaded on the loading unit.

10. A post-processing device comprising:
a loading unit on which media are loaded; and
the binding device according to claim 3 that binds the media loaded on the loading unit.

11. A post-processing device comprising:
a loading unit on which media are loaded; and
the binding device according to claim 4 that binds the media loaded on the loading unit.

12. A post-processing device comprising:
a loading unit on which media are loaded; and
the binding device according to claim 5 that binds the media loaded on the loading unit.

13. A post-processing device comprising:
a loading unit on which media are loaded; and
the binding device according to claim 6 that binds the media loaded on the loading unit.

14. A post-processing device comprising:
a loading unit on which media are loaded; and
the binding device according to claim 7 that binds the media loaded on the loading unit.

15. An image forming apparatus comprising:
an image recording device that records an image on a medium; and
the post-processing device according to claim 8 that performs post-processing on the medium on which the image is recorded by the image recording device.

16. An image forming apparatus comprising:
an image recording device that records an image on a medium; and
the post-processing device according to claim 9 that performs post-processing on the medium on which the image is recorded by the image recording device.

17. An image forming apparatus comprising:
an image recording device that records an image on a medium; and
the post-processing device according to claim 10 that performs post-processing on the medium on which the image is recorded by the image recording device.

18. An image forming apparatus comprising:
an image recording device that records an image on a medium; and
the post-processing device according to claim 11 that performs post-processing on the medium on which the image is recorded by the image recording device.

19. An image forming apparatus comprising:
an image recording device that records an image on a medium; and
the post-processing device according to claim 12 that performs post-processing on the medium on which the image is recorded by the image recording device.

20. An image forming apparatus comprising:
an image recording device that records an image on a medium; and
the post-processing device according to claim 13 that performs post-processing on the medium on which the image is recorded by the image recording device.
